(19) United States
(12) Patent Application Publication
(10) Pub. No.: US 2004/0068553 A1
(43) Pub. Date: Apr. 8, 2004

(54) Dynamically selecting a Web service container for hosting remotely instantiated Web services

(75) Inventors: Douglas B. Davis, Raleigh, NC (US); James M. Mathewson II, Chapel Hill, NC (US); Brad B. Topol, Raleigh, NC (US); Keith A. Wells, Angier, NC (US)

Correspondence Address: CHRISTOPHER & WEISBERG, P.A., 200 EAST LAS OLAS BOULEVARD, SUITE 2040, FORT LAUDERDALE, FL, 33301, US

(73) Assignee: International Business Machines Corporation, Armonk, NY

(21) Appl. No.: 10/265,844

(22) Filed: Oct. 7, 2002

(51) Int. Cl. G06F 15/16

(52) U.S. Cl. 709/218

(57) ABSTRACT

A container selector for use in a Web services architecture can include an application container query tool operably configured to query individual application containers for a list of supported libraries and associated configuration information. A comparator can be programmed to compare the list with another list of requisite libraries and associated configuration information specified for use by a requested Web service. Finally, a Web service clone requestor can be operably configured to request an instantiation of the Web service within a particular application container. Specifically, the particular container can be a new container where the comparator cannot identify an existing container having libraries and associated configuration information which match the requisite libraries and associated configuration information. Otherwise, the container can be a container in the list where the comparator can identify an existing container having libraries and associated configuration information which matches the requisite libraries and associated configuration information.

### BACKGROUND OF THE INVENTION

1. Statement of the Technical Field

The present invention relates to the field of Web services, and more particularly to instantiating Web service instances in an application container through the operation of a grid mechanism.

2. Description of the Related Art

Web services have become the rage of distributed computing and are viewed as the foundation for developing a truly universal model for supporting the rapid development of component-based applications over the World Wide Web. Web services are known in the art to include a stack of emerging standards that describe a service-oriented, component-based application architecture. Specifically, Web services are loosely coupled, reusable software components that semantically encapsulate discrete functionality and are distributed and programmatically accessible over standard Internet protocols.

Conceptually, Web services represent a model in which discrete tasks within computing processes are distributed widely throughout a value net. Notably, many industry experts consider the service-oriented Web services initiative to be the next evolutionary phase of the Internet. Typically, Web services can be defined by an interface such as the Web services definition language (WSDL), and can be implemented according to the interface, though the implementation details matter little so long as the implementation conforms to the Web services interface. Once a Web service has been implemented according to a corresponding interface, the implementation can be registered with a Web services registry, such as Universal Description, Discover and Integration (UDDI), as is well known in the art. Upon registration, the Web service can be accessed by a service requestor through the use of any supporting messaging protocol, including for example, the simple object access protocol (SOAP).

In a service-oriented application environment supporting Web services, locating reliable services and integrating those reliable services dynamically in realtime to meet the objectives of an application has proven problematic. While registries, directories and discovery protocols provide a base structure for implementing service detection and service-to-service interconnection logic, registries, directories, and discovery protocols alone are not suitable for distributed interoperability. Rather, a more structured, formalized mechanism can be necessary to facilitate the distribution of Web services in the formation of a unified application.

Notably, the physiology of a grid mechanism through the Open Grid Services Architecture (OGSA) can provide protocols both in discovery and also in binding of Web services, hereinafter referred to as “grid services”, across distributed systems in a manner which would otherwise not be possible through the exclusive use of registries, directories and discovery protocols. As described both in Ian Foster, Carl Kesselman, and Steven Tuecke, The Anatomy of the Grid, Intl J. Supercomputer Applications (2001), and also in Ian Foster, Carl Kesselman, Jeffrey M. Nick and Steven Tuecke, The Physiology of the Grid, Globus.org (Jun. 22, 2002), a grid mechanism can provide distributed computing infrastructure through which grid services instances can be created, named and discovered by requesting clients.

Grid services extend mere Web services by providing enhanced resource sharing and scheduling support, support for long-lived state commonly required by sophisticated distributed applications, as well as support for inter-enterprise collaborations. Moreover, while Web services alone address discovery and invocation of persistent services, grid services support transient service instances which can be created and destroyed dynamically. Notable benefits of using grid services can include a reduced cost of ownership of information technology due to the more efficient utilization of computing resources, and an improvement in the ease of integrating various computing components. Thus, the grid mechanism, and in particular, a grid mechanism which conforms to the OGSA, can implement a service-oriented architecture through which a basis for distributed system integration can be provided—even across organizational domains.

Both in a conventional Web services configuration, and in a Grid services configuration, a Web service creation process can be provided which is capable of creating and deploying new Web service instances. In both cases, and particularly, in the case of a Grid services architecture, during the process of cloning a Web services to a remote host, it must be determined whether the new instantiation of the Web service should reside in an existing Web application container, or whether the new instance of the Web service should reside in a newly created Web application container. Several factors can be considered in this determination. First, the execution environment and the availability of multiple supporting library versions must be considered. Specifically, it can be preferable to instantiate particular versions of a Web service in furtherance of compatibility or performance requirements.

Second, it can be preferable to functionally group particular Web services in a single Web application container. Finally, selecting particular Web application containers in which to instantiate a Web service can be a matter of user preference. Presently, the use of a particular Web application container in which a Web service instance can be deployed can be undertaken manually in a static manner according to the preferences of an application administrator. Yet, it would be particularly advantageous to programmatically select a Web application container to host a Web service instance according to the run-time requirements of an application end user. Thus, there exists a long felt, unsolved need for a programmatic method and system for dynamically selecting a Web service container for hosting remotely instantiated Web services.

### SUMMARY OF THE INVENTION

The present invention is a container selector for use in a Web services architecture. The container selector can include an application container query tool which has been operably configured to query individual application containers in a Web services host which can be accessed through the Web services architecture for a list of supported libraries and associated library configuration information. A comparator can be programmed to compare the list with another list of requisite libraries and associated library configuration information specified for use by a requested Web service.

Finally, a Web service clone requestor can be operably configured to request an instantiation of the Web service within an application container in the Web services host. Specifically, the application container can be a new application container where the comparator cannot identify an existing application container having libraries and associated library configuration information which matches the requisite libraries and associated library configuration information. Otherwise, the application container can be a specified application container where the comparator can identify an existing application container having libraries and associated library configuration information which matches the requisite libraries and associated library configuration information.

Notably, the application container query tool can be operably configured to query individual remotely positioned application containers in a remote Web services host. In particular, the application container query tool can perform the query through a remote service deployment processor in the Web services architecture. In that regard, the Web services architecture can be a grid architecture and the application container query tool can be a GridService queryByServiceDataName operation. Additionally, where the Web services architecture is a grid architecture, the application container query tool can be a GridService FindServiceData operation.

In any case, the container selecter further can include a match attribute table having at least one attribute selected from the group consisting of a less than attribute, a less than or equal attribute, an equal attribute, a greater than attribute, a greater than or equal attribute, a range attribute, and a not equal attribute, the comparator performing the comparison as directed by a match attribute defined in the table. Also, at least one of the individual application containers in the Web services host can include a versioning document having a listing of supported libraries and associated library parameters. Moreover, the associated library parameters can include versioning information.

In a Web services architecture, an application container selection method for selecting an application container to host an instance of a requested Web service can include identifying at least one specified supporting library. As used herein, the term “supporting library” can refer not only to supporting application libraries, but also to supporting executable and interpretable applications and other supporting files and logic. As such, individually one or more application containers can be queried for a list of supporting libraries associated with the application containers. From the list it can be determined whether any of the application containers has access to the specified supporting library.

As a result, the creation of an instance of the Web service can be requested in a particular application container. Namely, the particular application can be a new application container where it is determined that no existing application containers has access to the specified supporting library. Otherwise, the application container can be a particular one of the existing application containers where it is determined that the particular one of the existing application containers has access to the specified supporting library.

Importantly, each of the foregoing identifying, determining and requesting steps can be performed in a client process, while the querying step can be performed in a server process. Alternatively, a configuration file can be received from a client process wherein the configuration file can name the specified supporting library. Consequently, each of the identifying, determining and requesting steps can be performed in a server process. In both cases, however, the querying step can include querying through a remote service deployment processor, one or more remotely positioned application containers for a list of supporting libraries associated with the remotely positioned application containers.

### BRIEF DESCRIPTION OF THE DRAWINGS

There are shown in the drawings embodiments which are presently preferred, it being understood, however, that the invention is not limited to the precise arrangements and instrumentalities shown, wherein:

FIG. 1 is a block illustration of a Web services distribution architecture which has been configured in accordance with the present invention;

FIG. 2 is a flow chart illustrating a client-controlled process for selecting a container in which a Web service can be cloned to a remote host in the architecture of FIG. 1; and,

FIG. 3 is a flow chart illustrating a server-controlled process for selecting a container in which a Web service can be cloned to a remote host in the distribution architecture of FIG. 1.

### DETAILED DESCRIPTION OF THE PREFERRED EMBODIMENTS

The present invention is a method and system for selecting a Web services container for hosting a remotely instantiated Web service. Specifically, in accordance with the present invention, a requesting Web services client can specify to a Web services deployment process such as a factory create process of a Web services engine the type of supporting applications which are requisite to the operation of a requested Web service. In response, one of either an existing application container or a new application container can be selected to host a newly instantiated clone of the requested Web service based upon the presence of the specified supporting applications and libraries within a pre-existing container in a remote host. In this way, an application container can be programmatically selected to host the Web services instance according to the run-time requirements of an application end user.

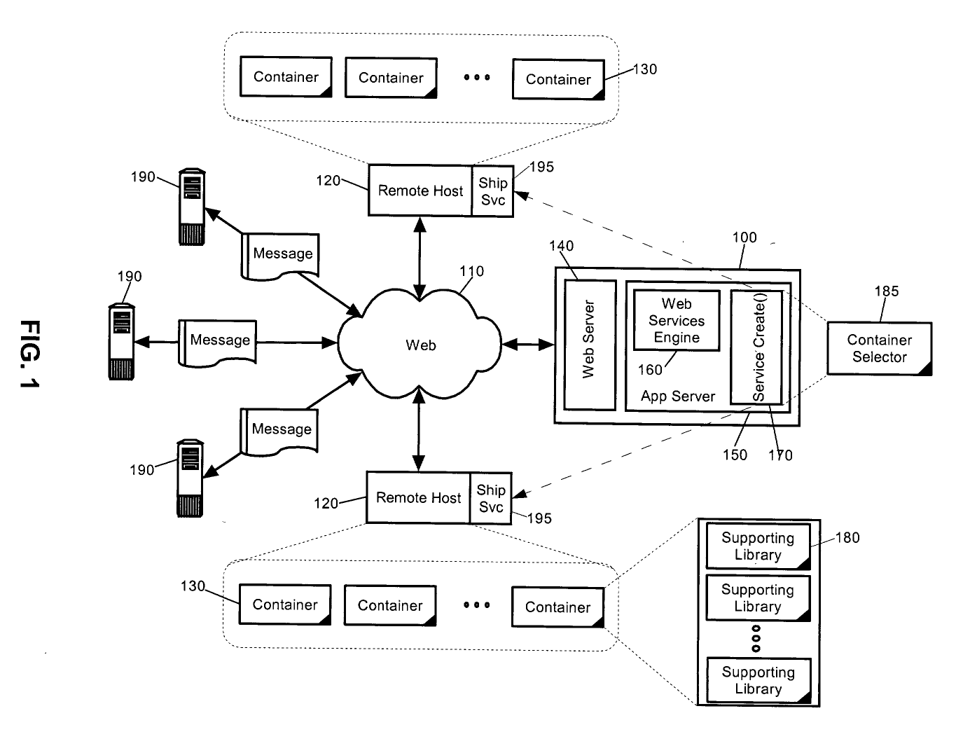

FIG. 1 is a block illustration of a Web services distribution architecture which has been configured in accordance with the present invention. As will be apparent to the skilled artisan, the Web services distribution architecture can be configured with one or more Web services hosts 100, 120 communicatively linked to one another across a computer communications network 110, for instance the Internet. Individual requesting clients 190 can request access to Web services from one or more of the Web services hosts 100, 120. Specifically, as is well-known in the art, SOAP encoded messages can be exchanged between requesting clients 190 and the Web services hosts 100, 120. The messages can include requests to discover the location of particular Web services and well as responses to the requests in which the network location of the requested Web services are revealed.

The Web services hosts 100, 120 can be disposed within a server computing device in a centralized fashion, or across multiple server computing devices in a distributed fashion. In either case, a Web server 140 can be provided which can be configured to respond to network requests for content, such as markup documents. As will be understood by one of ordinary skill in the art, the Web server 140 can be configured to handle SOAP messages over the hypertext transfer protocol (HTTP) or other such transport protocol, and to distribute markup such as hypertext markup language (HTML) formatted documents, extensible markup language (XML) formatted documents, and the like.

The Web server 140 can be communicatively linked in the Web services host 100, 120 to an application server 150. Application servers are well-known in the art and typically are configured to process machine code, whether in an interpreted manner, or in a native format. Conventional application servers process server-side logic such as scripts and servlets. In any event, the application server 150 can be linked to a Web services engine 160 which has been operably configured to instantiate individual Web services in one or more Web services containers 130. Importantly, each Web services container 130 can access one or more supporting libraries and applications 180, such as a markup parser or a markup transcoder. In that regard, Web services operating within a container 130 can access the operational functionality of the supporting libraries 180.

Importantly, a Web services creation process 170, such as a factory create service, can be disposed in each Web services host 100, 120. The Web services creation process 170 can implement a service create interface in accordance with a conventional Web services architecture, or the Web services creation process 170 can implement a grid services interface such as that defined by OGSA and specified, for example, according to the Globus Project, Globus Toolkit Futures: An Open Grid Services Architecture, Globus Tutorial, Argonne National Laboratory (Jan. 29, 2002).

As is well-known in the art, an OGSA compliant grid services interface can include the following interfaces and behaviors:

Web service creation (Factory)

Global naming (Grid Service Handle) and references (Grid Service Reference)

Lifetime management

Registration and discovery

Authorization

Notification

Concurrency

Manageability

In that regard, where the Web services creation process 170 can be a factory create service, the factory create service can include a factory interface able to clone instances of selected Web services into new or pre-existing application containers using “Factory CreateService( )”.

Significantly, the Web services creation process 170 can instantiate clone instances of a requested Web service across one or more remote hosts 120. In particular, where the invention has been configured for operation in a Grid architecture, consistent with the intent of Grid architectures, where processing loads experienced by individual remote hosts 120 exceed acceptable or pre-specified capacities, others of the individual remote hosts 120 can be selected to host new instances of selected Web services. To facilitate the cloning and instantiation of Web services in a remote host, a remote service deployment processor 195 can be disposed in the remote host 120.

Specifically, a requested Web service can be archived within the Web services creation process 170 along with an associated deployment descriptor and implementation document. The archive can be forwarded from the Web services creation process 170 to the remote service deployment processor 195 in the remote host 120 which can expand the archive variably to one of an existing or newly created application container 130.

The Web service can be assigned a unique identity in the remote host 120, and in consequence, the Web service implementation document can be modified to reference with specificity, not only the identity of the remote host 120, but also the unique identity of the Web service in the remote host 120. Additionally, to the extent a new Web service interface document will be required for use with the Web service, the Web service implementation document can be modified to reference the location of the Web service interface document in the remote host 120.

Importantly, a deployment descriptor associated with the Web service can be modified to reflect the unique identity of the Web service. Once the deployment descriptor has been modified, the modified deployment descriptor can be passed to a Web services engine in the remote host 120 so that the Web services engine can deploy the Web service in the remote host 120. Subsequently, a network reference to the modified Web service implementation document can be returned to the Web services creation process 170 so that the Web services engine 160 in the Web services host 100 can publish and utilize the remotely deployed Web service as need be.

Importantly, particular application containers 130 residing within one or more remote hosts 120 can be selected to host a new instance of a requested Web service. Alternatively, a new application container (not shown) can be selected to host a new instance of a requested Web service. To facilitate the selection of either a new application container, or a particular existing application container 130 to host a requested Web service, a container selector 185 can be provided in association with the Web services creation process 170.

More particularly, the container selector 185 can selectively determine whether an existing application container 130 can host a requested Web service based upon several factors, such as execution environment and the version of available supporting libraries 180 in each application container 130, the functional grouping of Web services in an application container 130, or simple configuration preferences. Where a suitable pre-existing application container cannot be identified, a new application container can be requested in a remote host 120.

Notably, in accordance with the present invention, dual processes can be provided for selecting a desirous Web application container for hosting a requested Web service in a remote host. Specifically, both a client-controlled process and a server-controlled process can be provided. In the client-controlled process, a client process can query the Web services creation process 170 to determine whether existing application containers leveraged by the Web services creation process 170 can satisfy the computing requirements of a particular Web service.

Based upon the result, the client process can request that the Web services creation process 170 clone a requested Web service to either a new or an identified application container 130 in the remote host 120. By comparison, in the server-controlled process, the client process merely can provide the requisite computing requirements to the Web services creation process 170 for use by the Web services creation process 170 in identifying and selecting an application container 130 in which to clone the requested Web service.

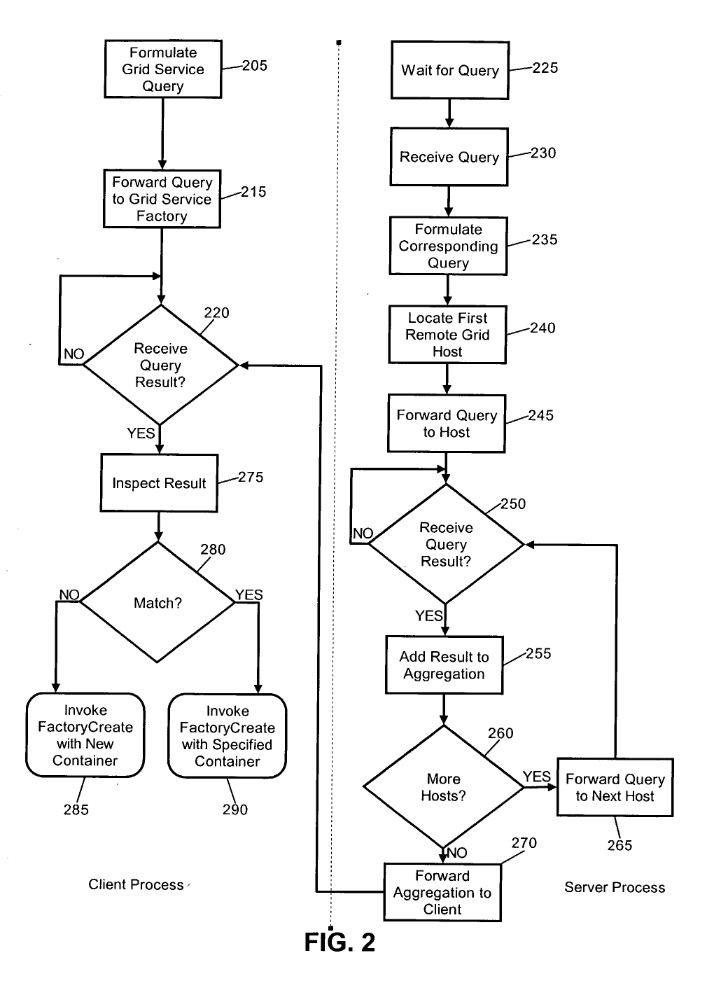

FIG. 2 is a flow chart illustrating a client-controlled process for selecting an application container in which a Web service can be cloned to a remote host in the Web services architecture of FIG. 1. Beginning in block 205, a client process can formulate a query to the Web services create process. The query can request, for instance, a list of available supporting applications resident within the application containers of one or more various remote hosts. As an example, in the OGSA context a client process can formulate the following query to return a list of application containers referenced by the name, “webappcontainers”:

<gsdl:queryByServiceDataName name=“webappcontainers”/>

Alternative methods in the OGSA context can utilize the GridService FindServiceData operation rather than the GridService queryByServiceDataName operation.

In any case, in block 215 the formulated query can be forwarded to the Web services create process and in block 220, the client process can await a response. Turning now to the server process, in block 225, the Web services create process can await a query. In block 230, the formulated query can be received and, in response, in block 235, a corresponding query can be constructed in a manner designed to obtain a listing of supporting applications operating in association with any one application container in any one Web services host.

In block 240, a first application container in the remote host which can be accessed, for example through a remote service deployment processor, can be located and in block 245 the query can be forwarded to the located application container, using for instance, the FindServiceData operation. In block 250, the FindServiceData operation can await a response from the located application container. Upon receipt of the query, the application container can inspect the versioning information for each accessible supporting application. Though any suitable method of obtaining the versioning information can suffice, in a preferred aspect of the invention, each supporting application container can publish its configuration information in a separate configuration document.

As an example, a “versions.xml” document can be stored in a META-INF directory associated with the application container. An exemplary configuration document has been illustrated in Appendix C. As will be apparent from the markup of Appendix C, the configuration document can list the name of each supported library or application in the application container, and an associated version. In this way, either through a direct examination of the configuration file, or through a query to a method in the application container itself, it can be determined what applications or libraries are resident or supported in the located application container.

In block 255, the listing of supported applications and libraries provided by the located application container can be incorporated into an aggregate listing. A typical response has been illustrated in Appendix A. In any case, in block 260, if more accessible application containers remain to be queried, in block 265, the query can be forwarded to the next located application container and the process can repeat. Ultimately, when each accessible application container has been queried, and the aggregate listing of supporting applications compiled, in block 270 the aggregation can be returned to the client process, for instance as an OGSA Service Data element in the form shown in Appendix B.

In block 275 in the client process, the result returned by the Web service creation process can be inspected to determine those supporting applications, libraries and associated version information which can be accessed by particular ones of the operable application containers in the remote host. Based upon this inspection, in block 280 the client process can determine whether any of the listed application containers can provide applications or libraries having a requisite version so as to satisfy the operating requirements of a desired Web service. Where no application containers can suffice, in block 285 the client process can invoke the creation of a selected Web service using a new application container. Otherwise, in block 290 the client process can invoke the creation of a selected Web service using an existing application container identified in block 280.

Importantly, while the client process can indicate in a clone request whether or not a new application container should be created to host a selected Web service in a remote host, the Web services create proces can override the preference of the client process. In particular, based upon security or authorization information, the Web services creation process can determine whether or not to honor the request of the client process. If, however, the Web services creation process does not honor the client process request, a corresponding notification can be provided to the client process rather than merely performing the cloning process to a server-selected application container.

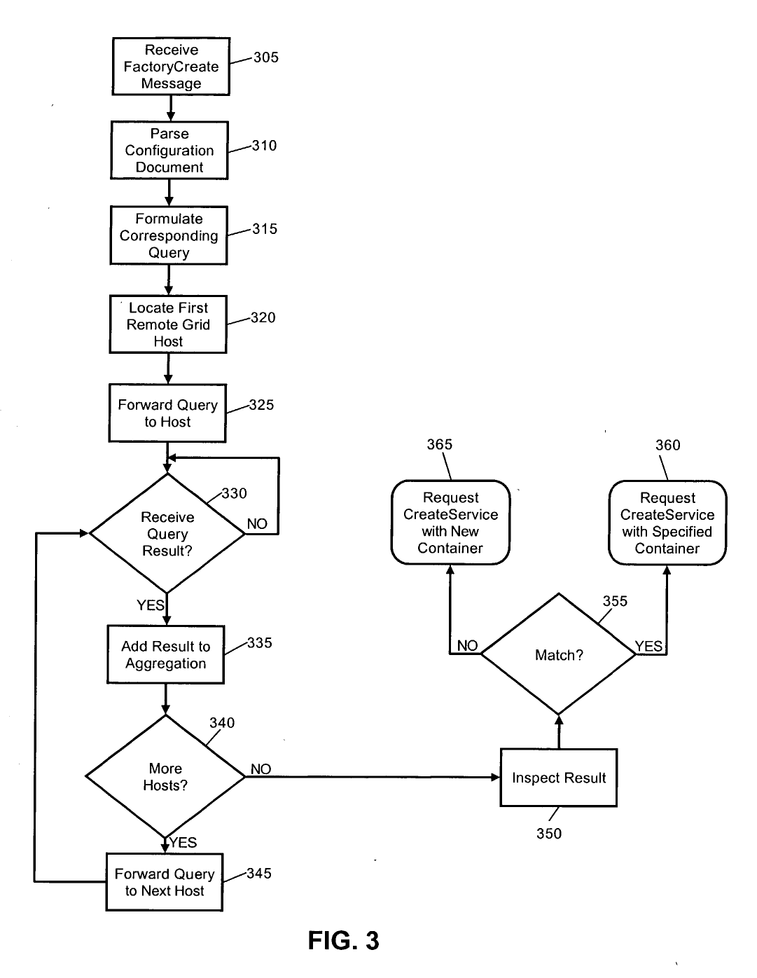

By comparison to FIG. 2, FIG. 3 is a flow chart illustrating a host-controlled process for selecting an application container in which a Web service can be cloned to a remote host in the Web services architecture of FIG. 1. Beginning in block 305, the Web services creation process can receive a request to clone a particular Web service to a remote host. Included with the request, for instance as a service parameter, a configuration file can specify the desired level of requisite supporting applications necessary for the satisfactory operation of the requested Web service. An exemplary configuration file might include, for instance:

<configuration>

<software name=”MyParser” version=“1.3” match=”eq”/>
<software name=”MyTranscoder” version=“2.0” match=”ge”/>

</configuration>

As will be apparent to one skilled in the art, the configuration file can be an XML file and can include a “match” attribute. Though the invention is not so limited to the particular form of attributes illustrated therein, a table of suitable attributes might include:

| Match | Definition |
|---|---|
| lt | Less than - Match any version less than the specified value |
| le | Less than or equal - Match any version less than or equal to the |
| | specified value |
| eq | Equal - Match this exact version |
| ne | Not Equal - Match any version except the specified version |
| gt | Greater than - Match any version greater than the specified |
| | value. |
| ge | Greater than or equal - Match any version greater than or equal |
| | to the specified value |
| range | Match one of the comma separated values in the version attribute |

Using the match attribute, the Web service creation process can determine whether identified supporting applications resident in accessible application containers in the remote host can satisfy the operational requirements of the requested Web service. Specifically, in block 310, the configuration file can be parsed and a query can be formulated in block 315 for retrieving a list of supporting applications from each accessible application container in the remote host. In block 320, a first application container which can be accessed, for example through a remote service deployment processor, can be located and in block 325 the query can be forwarded to the located application container, using for instance the FindServiceData operation. In block 330, the FindServiceData operation can await a response from the located application container.

In block 335, the listing of supported applications and libraries provided by the located application container can be incorporated into an aggregate listing. Again, a typical response has been illustrated in Appendix A. In any case, in block 340, if more accessible application containers remain to be queried, in block 345, the query can be forwarded to the next located application container and the process can repeat. Ultimately, when each accessible application container has been queried, and the aggregate listing of supporting applications and libraries compiled, in block 350 the aggregation can be inspected and the match attribute can be compared against the specific requirements of the requested Web service.

Based upon this inspection, in block 355 the Web service creation process can determine whether any of the listed application containers include applications or libraries of a requistie version so as to satisfy the operating requirements of a desired Web service. Where no application containers can suffice, in block 365 the client process can invoke the creation of a selected Web service using a new application container. Otherwise, in block 360 the client process can invoke the creation of a selected Web service using an existing application container identified in block 355.

In accordance with the present invention, remotely instantiated Web services can share Web application containers, and as a result, remotely instantiated Web services can share library resources. Also, the aggregation of supporting application configuration data can permit container selection logic to programmatically select a satisfactory container to host a requested Web service instance. Finally, in accordance with the inventive arrangements, a Web service creation process, or an OGSA factory create operation can undertake an informed decision-making process either to select an existing application container to host a requested Web service clone, or to request the creation of a new application container to host the requested Web service clone.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

[image]

We claim:

1. A container selector for use in a Web services architecture, the container selector comprising:
an application container query tool operably configured to query individual application containers in a Web services host which can be accessed through the Web services architecture for a list of supported libraries and associated library configuration information;
a comparator programmed to compare said list with another list of requisite libraries and associated library configuration information specified for use by a requested Web service; and,
a Web service clone requester operably configured to request an instantiation of said Web service within an application container in said Web services host selected from the group consisting of a new application container where said comparator cannot identify an existing application container having libraries and associated library configuration information which matches said requisite libraries and associated library configuration information, and a specified application container where said comparator can identify an existing application container having libraries and associated library configuration information which matches said requisite libraries and associated library configuration information.

2. The container selector of claim 1, wherein the Web services architecture is a grid architecture and said application container query tool is a GridService queryByServiceDataName operation.

3. The container selector of claim 1, wherein the Web services architecture is a grid architecture and said application container query tool is a GridService FindServiceData operation.

4. The container selector of claim 1, further comprising a match attribute table comprising at least one attribute selected from the group consisting of a less than attribute, a less than or equal attribute, an equal attribute, a greater than attribute, a greater than or equal attribute, a range attribute, and a not equal attribute, said comparator performing said comparison as directed by a match attribute defined in said table.

5. The container selector of claim 1, wherein said application container query tool is operably configured to query individual remotely positioned application containers in a remote Web services host which can be accessed through a remote service deployment processor in the Web services architecture for a list of supported libraries and associated library configuration information.

6. The container selector of claim 1, wherein at least one of said individual application containers in said Web services host comprises a versioning document comprising a listing of supported libraries and associated library parameters.

7. The container selector of claim 6, wherein said associated library parameters comprise versioning information.

8. In a Web services architecture, an application container selection method for selecting an application container to host an instance of a requested Web service, said method comprising the steps of:
identifying at least one specified supporting library;
querying individual ones of a plurality of application containers for a list of supporting libraries associated with said application containers;
determining from said list whether any of said application containers has access to said specified supporting library; and,
requesting the creation of an instance of the Web service in an application container selected from the group consisting of a new application container where it is determined that no existing application containers has access to said specified supporting library, and a particular one of said existing application containers where it is determined that said particular one of said existing application containers has access to said specified supporting library.

9. The method of claim 8, further comprising the steps of:
performing said identifying, determining and requesting steps in a client process; and,
performing said querying step in a server process.

10. The method of claim 8, further comprising the steps of:
receiving from a client process a configuration file naming said at least one specified supporting library; and,
performing said identifying, determining and requesting steps in a server process.

11. The method of claim 8, wherein said identifying step further comprises the step of identifying at least one supporting library configuration parameter associated with said at least one specified supporting library.

12. The method of claim 11, wherein said querying step comprises the step of querying individual ones of a plurality of application containers for a list of supporting libraries and corresponding supporting library configuration parameters, and wherein said determining step comprises the step of determining from said list whether any of said application containers has access to said specified supporting library wherein said specified supporting library has corresponding configuration parameters which satisfy a particular matching rule.

13. The method of claim 12, wherein said matching rule comprises an application of an attribute selected from the group consisting of a less than attribute, a less than or equal attribute, an equal attribute, a greater than attribute, a greater than or equal attribute, a range attribute, and a not equal attribute.

14. The method of claim 8, wherein said querying step comprises the step of querying through a remote service deployment processor, individual ones of a plurality of remotely positioned application containers for a list of supporting libraries associated with said remotely positioned application containers.

15. A machine readable storage having stored thereon a computer program for selecting an application container to host an instance of a requested Web service in an grid services architecture, the computer program comprising a routine set of instructions which when executed cause the machine to perform the steps of:
identifying at least one specified supporting library;
querying individual ones of a plurality of application containers for a list of supporting libraries associated with said application containers;
determining from said list whether any of said application containers has access to said specified supporting library; and,
requesting the creation of an instance of the Web service in an application container selected from the group consisting of a new application container where it is determined that no existing application containers has access to said specified supporting library, and a particular one of said existing application containers where it is determined that said particular one of said existing application containers has access to said specified supporting library.

16. The machine readable storage of claim 15, further comprising the steps of:
performing said identifying, determining and requesting steps in a client process; and,
performing said querying step in a server process.

17. The machine readable storage of claim 15, further comprising the steps of:
receiving from a client process a configuration file naming said at least one specified supporting library; and,
performing said identifying, determining and requesting steps in a server process.

18. The machine readable storage of claim 15, wherein said identifying step further comprises the step of identifying at least one supporting library configuration parameter associated with said at least one specified supporting library.

19. The machine readable storage of claim 18, wherein said querying step comprises the step of querying individual ones of a plurality of application containers for a list of supporting libraries and corresponding supporting library configuration parameters, and wherein said determining step comprises the step of determining from said list whether any of said application containers has access to said specified supporting library wherein said specified supporting library has corresponding configuration parameters which satisfy a particular matching rule.

20. The machine readable storage of claim 19, wherein said matching rule comprises an application of an attribute selected from the group consisting of a less than attribute, a less than or equal attribute, an equal attribute, a greater than attribute, a greater than or equal attribute, a range attribute, and a not equal attribute.
